(19) United States
(12) Patent Application Publication
(10) Pub. No.: US 2024/0158604 A1
(43) Pub. Date: May 16, 2024

(54) Electrically Conductive Compositions for Battery Electrode Plates

(71) Applicant: SHPP GLOBAL TECHNOLOGIES B.V., Bergen op Zoom (NL)

(72) Inventors: Norberto SILVI, Selkirk, NY (US); Paul Scott LONG, Selkirk, NY (US); Walter THOMPSON, Wilmington, DE (US); Matthew NIEMEYER, Pittsfield, MA (US); Scott DAVIS, Pittsfield, MA (US)

(21) Appl. No.: 18/281,605

(22) PCT Filed: Mar. 16, 2022
(86) PCT No.: PCT/IB2022/052395

§ 371 Date: Sep. 12, 2023

Related U.S. Application Data
(60) Provisional application No. 63/162,615, filed on Mar. 18, 2021.

(51) Int. Cl. C08K 3/04

(52) U.S. Cl. CPC C08K 3/04; C08K 2201/001; C08K 2201/006; C08K 2201/014

(57) ABSTRACT

Aspects of the disclosure relate to a composition including: from about 35 wt % to about 70 wt % of at least one polyethylene polymer; from about 25 wt % to about 55 wt % of at least one graphite filler; and from about 2 wt % to about 15 wt % of a carbon powder filler having a BET surface area of at least 50 square meters per gram (m²/g). The polyethylene polymer has a density of at least 0.94 gram per cubic centimeter (g/cm³), a melt flow rate (MFR) of at least 10 g per 10 minutes (g/10 min) measured at 190° C. and 21.6 kilogram (kg), and an Environmental Stress-Cracking Resistance (ESCR) of at least 500 hours. The composition has a volume electrical resistivity of less than 5 ohm·centimeter (ohm·cm) and a MFR of at least 4 g/10 min measured at 280° C. and 21.6 kg.

### FIELD OF THE DISCLOSURE

The present disclosure relates to thermoplastic compositions having high electrical conductivity, and in particular to polyethylene-based compositions including graphite filler and carbon powder that are suitable for use in battery electrode applications.

### BACKGROUND OF THE DISCLOSURE

There has been a longstanding search for carbon-plastic electrode compositions to use as electrode plates in zinc bromide batteries. U.S. Pat. No. 4,169,816 (the “'816 patent”) by Exxon Research & Engineering, for example, describes a homogeneous blend of a crystalline polypropylene-ethylene copolymer, an electrically conductive carbon black, a small quantity of silica, and a fiber-reinforcing agent selected from carbon fibers and mixtures of carbon and glass fibers. An example composition was reported to have excellent strength, good extrudability, excellent volume resistivity (1 Ohm·cm), and good impermeability. The '816 patent provides that to impart electrical conductivity the composition should contain at least 15 parts by weight of a finely divided conductive carbon powder per hundred parts (pph) of the copolymer. Further, up to 35 pph of the conductive carbon should not be employed or the composition is too brittle and also less easily extrudable into thin nonporous sheets. Further, a high carbon content tends to increase the permeability of thin sheets manufactured from such compositions to liquids such as bromine, as an example.

Johnson Controls began research into plastic-carbon electrodes in the 1990s, reporting at the time that the polypropylene-ethylene copolymer based electrodes developed by Exxon were susceptible to oxidative attack, swelling and warpage. The mechanism behind the bromide attack was said to be the vulnerability of tertiary hydrogens in the backbone of the propylene chain. To avoid this problem Johnson Controls selected high density polyethylene (HDPE) homopolymer; which was found to eliminate most, if not all, tertiary hydrogens on the backbone chain. Johnson Controls reported positive results in aging studies with the base polymer substitution; HDPE was superior to ethylene propylene (EP) copolymer.

U.S. Pat. No. 5,173,362 (the “'362 patent”) issued in December 1992 to Globe-Union Inc. described HDPE-based carbon-plastic electrodes and compositions for electrode systems, particularly those to be used for bipolar electrodes in zinc-bromine batteries. These compositions preferably included carbon-black as a conductive filler in a polymeric matrix, with reinforcing materials such as glass fibers. The warpage of the zinc-bromine electrodes experienced in the prior art, and which was believed to be caused by physical expansion of the electrodes due to bromine absorption by the material of the electrode, was substantially eliminated in the compositions and fabrication processes described in this invention. In the '362 patent materials were prepared using a lamination or a slurry process. Bromination, unlike chlorination, is extremely selective to the chemistry of the polymer matrix used, and the tertiary hydrogens of polypropylene systems react approximately twenty thousand times faster with bromine than the secondary hydrogens in polyethylene. Three carbon blacks were used in the compositions of this invention, but the Ketjenblack EC 300J grade offered the best combination of electrical conductivity and processability properties for the amount of carbon used.

The '362 patent claims “A substrate for a bipolar battery comprising a thermoplastic resin, a glass fiber filler, and a conductive carbon black powder prepared by a process including the following steps: compounding a mixture of the resin and the conductive powder; preparing at least one glass fiber mat of the fiber filler; conveying the mat along a straight path; introducing molten compound resin and powder onto said mat; pressing the mat to impregnate same with molten resin containing conductive powder; and cooling the impregnated mat to form a sheet substrate and wherein the substrate includes about 10 to 70 weight percent glass fibers and about 5 to 40 wt % carbon black, the balance being resin.” Despite the broad claim for carbon fiber loading, Table 4 of the patent describes carbon loadings of 18 wt % (identical to Exxon), so it is presumed that the carbon and fiber loadings used in the Johnson Controls patent are close to those disclosed in Exxon's '816 patent.

Accordingly, formulations containing high density polyethylene and different sources of carbon have been described in the prior art, but none showed the balance of electrical conductivity, chemical resistance, and processability required to manufacture thin sheets for battery electrode plates using a conventional sheet extrusion process.

These and other shortcomings are addressed by aspects of the present disclosure.

### SUMMARY

Aspects of the disclosure relate to a composition including: from about 35 wt % to about 70 wt % of at least one polyethylene polymer; from about 25 wt % to about 55 wt % of at least one graphite filler; and from about 2 wt % to about 15 wt % of a carbon powder filler having a BET surface area of at least 50 square meters per gram (m²/g) as determined in accordance with ASTM D3037. The polyethylene polymer has a density of at least 0.94 gram per cubic centimeter (g/cm³) as determined in accordance with ASTM D1505, a melt flow rate (MFR) of at least 10 g per 10 minutes (g/10 min) measured at 190° C. and 21.6 kilogram (kg) in accordance with ASTM D1238, and an Environmental Stress-Cracking Resistance (ESCR) measured in a 100% Igepal solution of at least 500 hours in accordance with ASTM D1693. The composition has a volume electrical resistivity of less than 5 ohm·centimeter (ohm·cm) measured in accordance with ASTM D991 or ASTM D257, and a MFR of at least 4 g/10 min measured at 280° C. and 21.6 kg in accordance with ASTM D1238. The combined weight percent value of all components does not exceed 100 wt %, and all weight percent values are based on the total weight of the composition.

Further aspects of the disclosure relate to a method for forming a composition including from about 35 wt % to about 70 wt % of at least one polyethylene polymer, from about 25 wt % to about 55 wt % of at least one graphite filler, and from about 2 wt % to about 15 wt % of a carbon powder filler having a BET surface area of at least 50 square meters per gram (m²/g) as determined in accordance with ASTM D3037. The method includes combining the at least one polyethylene polymer, the at least one graphite filler and the carbon powder filler to form a mixture; and extruding the mixture to form the composition. The polyethylene polymer has a density of at least 0.94 gram per cubic centimeter (g/cm³) as determined in accordance with ASTM D1505, a melt flow rate (MFR) of at least 10 g per 10 minutes (g/10 min) measured at 190° C. and 21.6 kilogram (kg) in accordance with ASTM D1238, and an Environmental Stress-Cracking Resistance (ESCR) measured in a 100% Igepal solution of at least 500 hours in accordance with ASTM D1693. The composition formed according to the method has a volume electrical resistivity of less than 5 ohm·centimeter (ohm·cm) measured in accordance with ASTM D991 or ASTM D257, and a MFR of at least 4 g/10 min measured at 280° C. and 21.6 kg in accordance with ASTM D1238. The combined weight percent value of all components does not exceed 100 wt %, and all weight percent values are based on the total weight of the composition.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document.

FIG. 1 is a graph depicting melt flow and volume resistivity for comparative compositions and example compositions formed according to aspects of the disclosure.

### DETAILED DESCRIPTION

The present disclosure relates to highly-filled plastic materials to replace titanium in electrode plates of zinc bromide flow batteries. Aspects of the disclosure related to compositions including at least one high density polyethylene and a mixture of synthetic graphite and conductive carbon black in different ratios. The compositions have good electrical conductivity, chemical resistance and processability into thin plastic sheets using conventional polymer processing methods.

In particular aspects the polyethylene is an ethylene-hexene copolymer of medium to high density. Synthetic, high purity graphites and carbon black powders of different particle sizes were used as fillers to impart electrical conductivity to the formulations of this invention. These PE-graphite-carbon compositions were injection molded into plaques, and also extruded into sheets of different thicknesses, which were used successfully to manufacture electrode plates for zinc-bromide batteries.

It was found that the choice of the polymer matrix affected the chemical resistance of the composition to the electrolyte solution used in the flow battery, with low density polyethylenes showing—in general—a poor response to the environmental conditions encountered by the electrode plate material inside the battery. In contrast, copolymers of high density polyethylene and hexene of at least 45% crystallinity have excellent resistance to zinc bromide at the relatively high operating temperatures of the battery. Graphites suitable for use in aspects of the disclosure are highly crystalline materials of high purity, which are produced at ultra-high temperatures that vaporize impurities such as metal oxides, sulfur, iron, aluminum and many others to render 99%+ pure carbon synthetic graphite in particle sizes from less than 1 micron to several hundreds of microns. The carbon filler used in aspects of the disclosure have a primary/basic particle size of some 10-50 nm, with aggregates of several hundreds of nanometers in size, and agglomerates as large as 100-200 microns.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polyethylene polymer” includes mixtures of two or more polyethylene polymers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein, the terms “number average molecular weight” or “Mₙ” can be used interchangeably, and refer to the statistical average molecular weight of all the polymer chains in the sample and is defined by the formula:

$${M}_{n} = \frac{\sum {N}_{i} {M}_{i}}{\sum {N}_{i}} ,$$

where Mᵢ is the molecular weight of a chain and Nᵢ is the number of chains of that molecular weight. Mₙ can be determined for polymers, e.g., polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “M_{w}” can be used interchangeably, and are defined by the formula:

$${M}_{w} = \frac{\sum {N}_{i} {M}_{i}^{2}}{\sum {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g., polycarbonate polymers, by methods well known to a person having ordinary skill in the art using molecular weight standards, e.g., polycarbonate standards or polystyrene standards, preferably certified or traceable molecular weight standards.

As used herein, the terms “polydispersity index” or “PDI” can be used interchangeably, and are defined by the formula:

$$PDI = \frac{{M}_{w}}{{M}_{n}} .$$

The PDI has a value equal to or greater than 1, but as the polymer chains approach uniform chain length, the PDI approaches unity.

The terms “residues” and “structural units”, used in reference to the constituents of the polymers, are synonymous throughout the specification.

As used herein the terms “weight percent,” “wt %,” and “wt %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Compositions

Aspects of the disclosure relate to a composition including: from about 35 wt % to about 70 wt % of at least one polyethylene polymer; and from about 25 wt % to about 55 wt % of at least one graphite filler; and from about 2 wt % to about 15 wt % of a carbon powder filler having a BET surface area of at least 50 square meters per gram (m²/g) as determined in accordance with ASTM D3037. The polyethylene polymer has a density of at least 0.94 gram per cubic centimeter (g/cm³) as determined in accordance with ASTM D1505, a melt flow rate (MFR) of at least 10 g per 10 minutes (g/10 min) measured at 190° C. and 21.6 kilogram (kg) in accordance with ASTM D1238, and an Environmental Stress-Cracking Resistance (ESCR) measured in a 100% Igepal solution of at least 500 hours in accordance with ASTM D1693. Further, the composition has a volume electrical resistivity of less than 5 ohm·centimeter (ohm·cm) measured in accordance with ASTM D991 or ASTM D257, and the composition has a MFR of at least 4 g/10 min measured at 280° C. and 21.6 kg in accordance with ASTM D1238. The combined weight percent value of all components does not exceed 100 wt %, and all weight percent values are based on the total weight of the composition.

In some aspects the polyethylene polymer includes a copolymer including ethylene monomer and hexene monomer. Combinations of polyethylene polymers and/or copolymers may also be used. Examples of such copolymers include, but are not limited to, Formolene® HL5010, Primatop™ MDPE 003938, and Marlex® HUM 4903. In further aspects the polyethylene polymer includes a copolymer including ethylene monomer and one or more monomers that may include, but are not limited to, 1-butene, 1-hexene, 1-octene, 1-decene, 1-octadecene, and 4-methyl-1-pentene.

In certain aspects the polyethylene polymer has a degree of crystallinity of at least 50% as determined by differential scanning calorimetry (DSC). In further aspects the polyethylene polymer has a degree of crystallinity of from 50% to 95% as determined by differential scanning calorimetry (DSC). In specific aspects the polyethylene polymer has a degree of crystallinity of from 50% to 90%, of from 50% to 70%, of from 50% to 61%, or of from 50% to 60%.

The graphite filler may in some aspects be a synthetic graphite. Exemplary graphite fillers include, but are not limited to, Asbury 1125, TIMREX® KS4, TIMREX® KS44, and combinations thereof.

As discussed herein the carbon powder filler has a BET surface area of at least 50 square meters per gram (m²/g) as determined in accordance with ASTM D3037. In further aspects the carbon powder filler has a BET surface area of at least 60 square meters per gram (m²/g) as determined in accordance with ASTM D3037.

Compositions according to aspects of the disclosure may also have good thermal conductivity properties. Thermal properties are affected by the filler type and loading levels; these (in turn) affect extrusion/sheeting characteristics.

In some aspects the compositions may be extruded into a sheet. In further aspects the compositions may be extruded, injection molded, compression molded, injection-compression molded, thermoformed, or some combination of these processes. Sheets of varying thickness may be formed. In some aspects the compositions may be formed into sheets having a thickness of up to 3 mm or greater. In further aspects thin sheets of from 0.020″ to 0.060″ may be formed. As discussed herein extrusion forming may be a desirable process for making these thin sheets.

### Methods of Manufacture

The one or any foregoing components described herein may be first dry blended with each other, or dry blended with any combination of foregoing components, then fed into an extruder from one or multi-feeders, or separately fed into an extruder from one or multi-feeders. The fillers used in the disclosure may also be first processed into a masterbatch, then fed into an extruder. The components may be fed into the extruder from a throat hopper or any side feeders.

The extruders used in the disclosure may have a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, co-kneaders, disc-pack processors, various other types of extrusion equipment, or combinations including at least one of the foregoing.

The components may also be mixed together and then melt-blended to form the thermoplastic compositions. The melt blending of the components involves the use of shear force, extensional force, compressive force, ultrasonic energy, electromagnetic energy, thermal energy or combinations including at least one of the foregoing forces or forms of energy.

The barrel temperature on the extruder during compounding can be set at the temperature where at least a portion of the polymer has reached a temperature greater than or equal to about the melting temperature, if the resin is a semi-crystalline organic polymer, or the flow point (e.g., the glass transition temperature) if the resin is an amorphous resin.

The mixture including the foregoing mentioned components may be subject to multiple blending and forming steps if desirable. For example, the thermoplastic composition may first be extruded and formed into pellets. The pellets may then be fed into a molding machine where it may be formed into any desirable shape or product. Alternatively, the thermoplastic composition emanating from a single melt blender may be formed into sheets or strands and subjected to post-extrusion processes such as annealing, uniaxial or biaxial orientation.

The temperature of the melt in the present process may in some aspects be maintained as low as possible in order to avoid excessive thermal degradation of the components. In certain aspects the melt temperature is maintained between about 230° C. and about 350° C., although higher temperatures can be used provided that the residence time of the resin in the processing equipment is kept relatively short. In some aspects the melt processed composition exits processing equipment such as an extruder through small exit holes in a die. The resulting strands of molten resin may be cooled by passing the strands through a water bath. The cooled strands can be chopped into pellets for packaging and further handling.

The compositions may be formed into sheets as described herein.

### Articles of Manufacture

In certain aspects, the present disclosure pertains to shaped, formed, or molded articles including the thermoplastic compositions or sheets formed therefrom. The thermoplastic compositions can be molded into useful shaped articles by a variety of means such as injection molding, extrusion, rotational molding, blow molding and thermoforming to form articles and structural components of, for example, energy storage batteries, battery electrodes, plates for heat exchangers, personal or commercial electronics devices, including but not limited to cellular telephones, tablet computers, personal computers, notebook and portable computers, and other such equipment, medical applications, RFID applications, automotive applications, and the like. In a further aspect, the article is extrusion molded. In a still further aspect, the article is injection molded.

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1. A composition comprising, consisting of, or consisting essentially of:
from about 35 wt % to about 70 wt % of at least one polyethylene polymer;
from about 25 wt % to about 55 wt % of at least one graphite filler; and
from about 2 wt % to about 15 wt % of a carbon powder filler having a BET surface area of at least 50 square meters per gram (m²/g) as determined in accordance with ASTM D3037,
   wherein
the polyethylene polymer has a density of at least 0.94 gram per cubic centimeter (g/cm³) as determined in accordance with ASTM D1505, a melt flow rate (MFR) of at least 10 g per 10 minutes (g/10 min) measured at 190° C. and 21.6 kilogram (kg) in accordance with ASTM D1238, and an Environmental Stress-Cracking Resistance (ESCR) measured in a 100% Igepal solution of at least 500 hours in accordance with ASTM D1693,
the composition has a volume electrical resistivity of less than 5 ohm·centimeter (ohm·cm) measured in accordance with ASTM D991 or ASTM D257,
the composition has a MFR of at least 4 g/10 min measured at 280° C. and 21.6 kg in accordance with ASTM D1238,
the combined weight percent value of all components does not exceed 100 wt %, and all weight percent values are based on the total weight of the composition.

Aspect 2. The composition according to Aspect 1, wherein the polyethylene polymer comprises a copolymer comprising ethylene monomer and hexene monomer.

Aspect 3. The composition according to Aspect 1, wherein the polyethylene polymer comprises a copolymer comprising ethylene monomer and one or more monomers selected from the group consisting of: 1-butene, 1-hexene, 1-octene, 1-decene, 1-octadecene, and 4-methyl-1-pentene.

Aspect 4. The composition according to any of Aspects 1 to 3, wherein the polyethylene polymer has a degree of crystallinity of at least 50% as determined by differential scanning calorimetry (DSC).

Aspect 5. The composition according to Aspect 4, wherein the polyethylene polymer has a degree of crystallinity of from 50% to 95% as determined by differential scanning calorimetry (DSC).

Aspect 6. The composition according to any of Aspects 1 to 5, wherein the graphite is a synthetic graphite.

Aspect 7. The composition according to any of Aspects 1 to 6, wherein the carbon powder filler has a BET surface area of at least 60 square meters per gram (m²/g) as determined in accordance with ASTM D3037.

Aspect 8. An extruded sheet comprising the composition according to any of Aspects 1 to 7.

Aspect 9. The extruded sheet according to Aspect 8, wherein the sheet has a thickness of from 0.020 inches (in) to 0.060 in.

Aspect 10. A method for forming a composition comprising, consisting of, or consisting essentially of, from about 35 wt % to about 70 wt % of at least one polyethylene polymer, from about 25 wt % to about 55 wt % of at least one graphite filler, and from about 2 wt % to about 15 wt % of a carbon powder filler having a BET surface area of at least 50 square meters per gram (m²/g) as determined in accordance with ASTM D3037, the method comprising, consisting of, or consisting essentially of:
combining the at least one polyethylene polymer, the at least one graphite filler and the carbon powder filler to form a mixture; and
extruding the mixture to form the composition,
   wherein
the polyethylene polymer has a density of at least 0.94 gram per cubic centimeter (g/cm³) as determined in accordance with ASTM D1505, a melt flow rate (MFR) of at least 10 g per 10 minutes (g/10 min) measured at 190° C. and 21.6 kilogram (kg) in accordance with ASTM D1238, and an Environmental Stress-Cracking Resistance (ESCR) measured in a 100% Igepal solution of at least 500 hours in accordance with ASTM D1693,
the composition has a volume electrical resistivity of less than 5 ohm·centimeter (ohm·cm) measured in accordance with ASTM D991 or ASTM D257,
the composition has a MFR of at least 4 g/10 min measured at 280° C. and 21.6 kg in accordance with ASTM D1238,
the combined weight percent value of all components does not exceed 100 wt %, and all weight percent values are based on the total weight of the composition.

Aspect 11. The method according to Aspect 10, wherein the polyethylene polymer comprises a copolymer comprising ethylene monomer and hexene monomer.

Aspect 12. The method according to Aspect 10, wherein the polyethylene polymer comprises a copolymer comprising ethylene monomer and one or more monomers selected from the group consisting of: 1-butene, 1-hexene, 1-octene, 1-decene, 1-octadecene, and 4-methyl-1-pentene.

Aspect 13. The method according to any of Aspects 10 to 12, wherein the polyethylene polymer has a degree of crystallinity of at least 50% as determined by differential scanning calorimetry (DSC).

Aspect 14. The method according to Aspect 13, wherein the polyethylene polymer has a degree of crystallinity of from 50% to 95% as determined by differential scanning calorimetry (DSC).

Aspect 15. The method according to any of Aspects 10 to 14, wherein the graphite is a synthetic graphite.

Aspect 16. The method according to any of Aspects 10 to 15, wherein the carbon powder filler has a BET surface area of at least 60 square meters per gram (m²/g) as determined in accordance with ASTM D3037.

Aspect 17. The method according to any of Aspects 10 to 16, wherein the composition is extruded into a sheet.

Aspect 18. The method according to Aspect 17, wherein the sheet has a thickness of from 0.020 inches (in) to 0.060 in.

Aspect 19. The method according to any of Aspects 10 to 16, further comprising forming the composition into a sheet using an injection molding process, compression molding process, injection-compression molding process, thermoforming process, or a combination thereof.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Various compositions were formed using the components listed in Table 1:

TABLE 1
Raw Materials

| | | Density | MFR at 190° C./ | ESCR in | Degree of |
|---|---|---|---|---|---|
| | | (g/cm³) | 21.60 Kg | 100% Igepal | Crystal- |
| | Type of | (ASTM | (g/10 min) | (hour) | lization by |
| Polymer | Polyethylene | D1505) | (ASTM D1238) | (ASTM D1693) | DSC (%) |
| Formolene ® | Extra high MW | 0.949 | 10 | >600 | 61.5 |
| HL5010 | PE/hexene | | | | |
| | copolymer | | | | |
| Primatop ™ | Medium density | 0.938 | 0.30 (at 2.16 Kg) | >800 | 46.6 |
| MDPE | PE/hexene | | ~20-30 (at 21.6 Kg) | | |
| 003938 | copolymer | | | | |
| | natural | | | | |
| Marlex ® | High MW | 0.949 | 0.29 (at 2.16 Kg) | >1,000 | 58.6 |
| HHM 4903 | PE/hexene | | | | |
| | copolymer | | | | |

| | | | | BET SA |
|---|---|---|---|---|
| | | | | (m²/gr) |
| | | Carbon | Particle | (ASTM |
| Graphite | Type | (%) | Size | D3037) |
| Asbury | High purity, | 98-99.9 | 100 Mesh (150 micron (μm)): 34.68% | |
| 1125 | highly | | 200 Mesh (75 μm): 37.85% | |
| | crystalline | | 325 Mesh (44 μm): 6.64% | |
| TIMREX ® | Highly crystalline | >99.5 | D10 (Laser Diffraction) = 1.2 μm | 26 |
| KS4 | primary synthetic | | D50 (Laser Diffraction) = 2.4 μm | |
| | graphite | | D90 (Laser Diffraction) = 4.3 μm | |
| TIMREX ® | Highly crystalline | >99.5 | D10 (Laser Diffraction) = 4.1 μm | 9 |
| KS44 | primary synthetic | | D50 (Laser Diffraction) = 15.8 μm | |
| | graphite | | D90 (Laser Diffraction) = 44.8 μm | |

| | | BET SA | OAN | Medium |
|---|---|---|---|---|
| | | (m²/gr) | Absorption | Particle |
| Carbon | | (ASTM | (ml/100 g) | Diameter |
| Black | Type | D3037) | (ASTM D2414) | (nm) |
| Ketjenblack | Extra electrically | 800 | 365 | 40 |
| EC300J | conductive | | | |
| ENSACO ® | Electrically | 65 | 190 | 35 |
| 250G | conductive | | | |

### Example 1

Compositions shown in Table 2 were extruded and tested (all amounts in this and the other tables listed in wt %):

TABLE 2
Compositions of Example 1

| | HDPE | Graphite | Carbon black | | Volume Resistivity |
|---|---|---|---|---|---|
| | Formolene | Asbury | Ketjenblack | Total | (Ohm · cm) |
| Composition | HL5010 | 1125 | EC300J | carbon | ASTM D991 |
| C0 | 67 | 30 | 3 | 33 | Not tested |
| C1 | 47 | 50 | 3 | 53 | 21.0 |
| C2 | 64 | 30 | 6 | 36 | 67.3 |
| Ex1 | 54 | 40 | 6 | 46 | 3.0 |
| Ex2 | 44 | 50 | 6 | 56 | 0.4 and 0.5 |
| C3 | 34 | 60 | 6 | 66 | No sample |
| C4 | 27 | 70 | 3 | 73 | No sample |

The compositions of Example 1 were formed to evaluate the effect of graphite content on extrudability and volume resistivity. Compositions C0, C1, C2, Ex1 and Ex2 were extruded without difficulty. Compositions C3 and C4 were extruded with difficulty; these compositions are likely not scalable for commercial applicability. These results suggest that compositions including a graphite content higher than 50 wt %—and a total carbon content higher than 56 wt %—will be difficult to extrude. Further, to achieve a volume resistivity of 1.0 ohm·cm or less blends including as much as 50 wt % graphite and 6 wt % carbon black may be required.

The injection moldability of these compositions was then considered. Compositions C0, C1, C2, Ex1 and Ex2 were injection molded without difficulty at thicknesses of 2.5 millimeter (mm) and 2.0 mm and injection pressures of up to 30 k pounds per square inch (psi). Thinner samples, however, such as 0.025 inch to 0.050 inch (0.635 mm to 1.27 mm), would require excessive pressure in excess of 30 k psi. Thus, in particular aspects it may be desirable to form thin sheets (e.g., 0.025 inch to 0.050 inch) from extrusion or possibly injection-compression molding processes.

### Example 2

Additional compositions were prepared in an attempt to achieve the volume resistivity of Ex2, but with improved flow. One-hundred pound (100-lb) samples were prepared and compounded at zone temperatures of from 480-520° F., a screw speed of 200 revolutions per minute (rpm), and a throughput of 20 lbs/hour. The compositions and performance are listed in Table 3:

TABLE 3
Compositions of Example 2

| | HDPE | Graphite | Carbon black | | Sheet |
|---|---|---|---|---|---|
| Sample | Formolene | Asbury | Ketjenblack | Total | extrusion |
| No. | HL5010 | 1125 | EC300J | carbon | processability |
| Ex3 | 49 | 45 | 6 | 51 | Good |
| C5 | 49 | 43 | 8 | 51 | Poor |
| C6 | 53 | 38 | 9 | 47 | Poor |

Sheets were extruded to a sheet thickness of 0.025″. Volume resistivity of the samples as measured in accordance with ASTM D991 was about 1.4 ohm·cm (Ex3), 0.75 ohm·cm (C5) and 0.76 ohm·cm (C6). The sheets of C5 and C6 had a tendency to exhibit edge cracking. Thus, the samples with higher carbon black loadings (C5 and C6) had improved volume resistivity properties but worse processability.

### Example 3

Composition Ex3 was tested for scalability; a 500-lb batch of resin was extruded on a commercial-size extruder into sheets of varying thickness. Sheets having a nominal thickness of 0.050″ and 0.037″ were successfully extruded, but the formulation was found to be too viscous for commercial production of sheets at 0.025″ thickness. Extruded sheets of around 0.050″ thick showed volume electrical resistivities of less than 3 ohm·cm when observed according to ASTM D991.

### Example 4

Additional compositions were prepared and tested to identify blends that had good processability (e.g., high melt flow rate) and low volume resistivity properties. The compositions and their properties are shown in Tables 4A and 4B:

TABLE 4A
Compositions of Example 4

| | HDPE Formolene | Primatop | Graphite | | | Ketjen black | |
|---|---|---|---|---|---|---|---|
| Comp. | HL5010 | MDPE 003938 | Asbury 1125 | TIMREX KS4 | TIMREX KS44 | EC300J | ENSACO 250G |
| Ex4 | 49 | | 45 | | | 6 | |
| C7 | 54 | | | | 38 | 8 | |
| C8 | 58 | | | | 33 | 9 | |
| C9 | 54 | | | | 38 | | 8 |
| Ex5 | 54 | | | 8 | 30 | | 8 |
| Ex6 | 54 | | | 13 | 25 | | 8 |
| C10 | 56 | | | 8 | 30 | 6 | |
| C11 | 56 | | | 13 | 25 | 6 | |
| C12 | 58 | | | 30 | 8 | 4 | |
| C13 | 59 | | | 7 | 28 | 6 | |
| C14 | 59 | | | 12 | 23 | 6 | |
| C15 | 59 | | | 28 | 7 | 6 | |
| C16 | 57 | | | 7 | 28 | | 8 |
| C17 | 57 | | | 12 | 23 | | 8 |
| Ex7 | 57 | | | 28 | 7 | | 8 |
| C18 | 65 | | | 6 | 24 | | 5 |
| C19 | 65 | | | 10 | 20 | | 5 |
| C20 | 65 | | | 24 | 6 | | 5 |
| Ex8 | | 49 | 45 | | | 6 | |
| Ex9 | 38 | 16 | | | 38 | 8 | |
| Ex10 | 39 | 17 | | 13 | 25 | 6 | |
| C21 | 58 | | | 7.6 | 30.4 | 4 | |

TABLE 4B
Properties of Table 4A Compositions

| | | | | | Melt Flow Rate | Volume Resistivity |
|---|---|---|---|---|---|---|
| | Total | Total | Total | Total | (g/10 min) at | (Ohm · cm) |
| Comp. | graphite | carbon black | carbon | HDPE | 280° C., 21.6 Kg | ASTM D991 |
| Ex4 | 45 | 6 | 51 | 49 | 9.97 | 1.9 |
| C7 | 38 | 8 | 46 | 54 | 2.06 | 1.1 |
| C8 | 33 | 9 | 42 | 58 | 2.78 | 1.1 |
| C9 | 38 | 8 | 46 | 54 | 5.73 | 9.8 |
| Ex5 | 38 | 8 | 46 | 54 | 4.87 | 4.7 |
| Ex6 | 38 | 8 | 46 | 54 | 5.09 | 3.8 |
| C10 | 38 | 6 | 44 | 56 | 2.95 | 2.9 |
| C11 | 38 | 6 | 44 | 56 | 3.78 | 3.7 |
| C12 | 38 | 4 | 42 | 58 | 2.03 | 2.1 |
| C13 | 35 | 6 | 41 | 59 | 6.01 | 7.2 |
| C14 | 35 | 6 | 41 | 59 | 5.85 | 5.4 |
| C15 | 35 | 6 | 41 | 59 | 2.35 | 3.1 |
| C16 | 35 | 8 | 43 | 57 | 6.5 | 10.1 |
| C17 | 35 | 8 | 43 | 57 | 6.56 | 6.9 |
| Ex7 | 35 | 8 | 43 | 57 | 4.71 | 3.5 |
| C18 | 30 | 5 | 35 | 65 | 18.4 | 1222 |
| C19 | 30 | 5 | 35 | 65 | 17.5 | 680 |
| C20 | 30 | 5 | 35 | 65 | 14.1 | 68.1 |
| Ex8 | 45 | 6 | 51 | 49 | 18.8 | 1.7 |
| Ex9 | 38 | 8 | 46 | 54 | 5.56 | 1.0 |
| Ex10 | 38 | 6 | 44 | 56 | 4.86 | 3.0 |
| C21 | 38 | 4 | 42 | 58 | 6.45 | 25.1 |

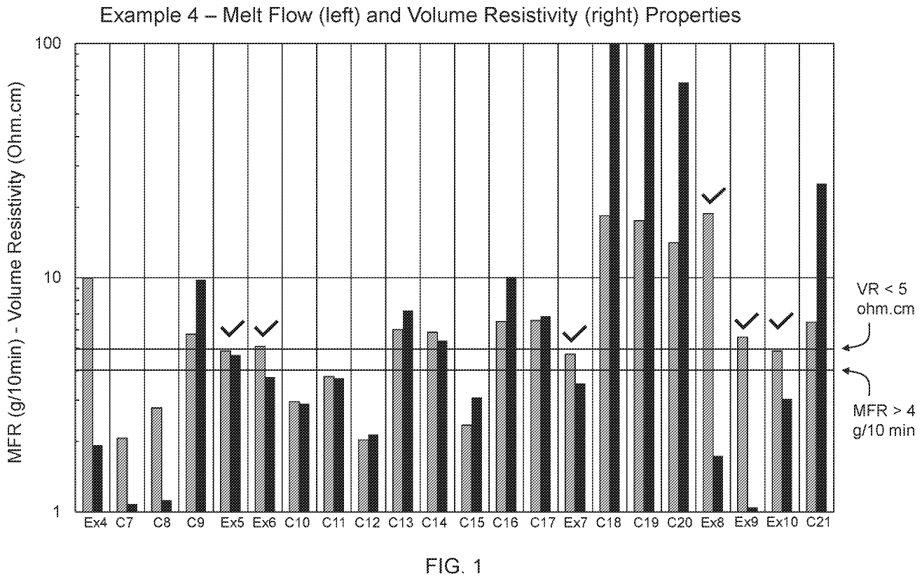

While several compositions had desirable melt flow (>4 g/10 min) or volume resistivity (<5 ohm·cm) properties, example compositions Ex4-Ex10 had a good combination of both melt flow and volume resistivity properties. The results may be visually observed in FIG. 1.

### Example 5

Further compositions were prepared and tested to identify scalable blends that had good processability (e.g., high melt flow rate) and low volume resistivity properties. The compositions were prepared on a commercial-size compounding extruder of 58 mm diameter, at barrel temperatures between 460° F. (238° C.) and 510° F. (266° C.), 360 rpm screw speed, and 52-56% of maximum torque. The extruder was run at rates of 120-140 Kg/hour. The compositions and their properties are shown in Tables 5A-5C:

TABLE 5A
Example and Comparative Compositions

| | HDPE | Primatop | Graphite | Ketjen | | |
|---|---|---|---|---|---|---|
| | Formolene | MDPE | TIMREX | black | Total | Total |
| Comp. | HL5010 | 003938 | KS44 | EC300J | Carbon | HDPE |
| Ex11 | 61 | | 29 | 10 | 39 | 61 |
| C22 | 18 | 36 | 38 | 8 | 46 | 54 |
| C23 | | 53 | 38 | 9 | 47 | 53 |

TABLE 5B
Properties of Table 5A Compositions

| | MFR 280° C., | Volume Resistivity |
|---|---|---|
| | 21.6 Kg | ASTM D257 |
| Composition | (g/10 min) | (Ohm · cm) |
| Ex11 | 10 | 2.7 |
| C22 | 12.1 | 2.7 |
| C23 | 11.7 | 2.7 |

As shown in Table 5B, the three scaled-up materials showed a MFR of 10 g/10 min or higher, and a volume electrical resistivity lower than 3 ohm·cm as measured on injection molded plaques according to ASTM D257. Some 750 pound (lb) samples of these resins were extruded successfully on commercial-size equipment into sheets having nominal thicknesses of 0.025″, 0.038″, and 0.050″. Extruded sheets of the three materials were tested for volume electrical resistivity according to ASTM D991 and observed values between about 2 ohm·cm and 7 ohm·cm depending on the thickness of the extruded sheet. Volume resistivity results are provided in Table 5C:

TABLE 5C
Volume Resistivity of Table 5A Compositions

| | | Volume Resistivity |
|---|---|---|
| | Thickness | (Ohm · cm) |
| Comp. | (inch) | (ASTM D991) |
| Ex11 | 0.025 | 5.8 |
| | 0.038 | 3.5 |
| | 0.050 | 2.1 |
| C22 | 0.025 | 6.2 |
| | 0.038 | 4.2 |
| | 0.051 | 2.4 |
| C23 | 0.025 | 7.4 |
| | 0.036 | 4.5 |
| | 0.045 | 2.4 |

The thicker samples had lower volume resistivity properties. Compositions C22 and C23 may not offer ideal chemical resistance properties in certain aspects, however, so the composition of Ex11 may be preferred.

### Example 6

ASTM plaques of the Ex11 composition were molded and tested for mechanical properties. These plaques were tested for tensile and flexural properties at room temperature (e.g., 23° C.) and at 60° C. The average mechanical properties for these plaques are shown in Table 6:

TABLE 6
Mechanical Properties of Ex11 Composition

| Property | Room Temperature | 60° C. |
|---|---|---|
| Tensile strength at | 31.8 | 18.7 |
| yield (megapascal) | | |
| (MPa) ASTM D 638 | | |
| Tensile strength at | 31.2 | 17.7 |
| break (MPa) | | |
| ASTM D 638 | | |
| Tensile Modulus (MPa) | 3590 | 1630 |
| ASTM D 638 | | |
| Tensile elongation at | 5.4 | 7.6 |
| yield (%) ASTM D 638 | | |
| Tensile elongation at | 7 | 12.2 |
| break (%) ASTM D 638 | | |
| Flexural strength at | 47 | 24.4 |
| yield (MPa) ASTM D 790 | | |
| Flexural modulus | 1870 | 651 |
| (MPa) ASTM D 790 | | |
| Coefficient of thermal | Flow = 114, xFlow (cross flow) = 125 | |
| expansion from 23-60° C. | | |
| (μm/(m-° C.) TMA | | |

Five 4″×5″×⅛″ thick injection molded plaques of the Ex11 composition were tested for volume electrical resistivity and averaged about 1 ohm·cm as tested in accordance with ASTM D991.

### Example 7

Additional samples were prepared to identify compositions having a good balance of flow/processability, volume resistivity and chemical resistance properties. The compositions formed are shown in Table 7A; electrical conductivity properties of the compositions are shown in Table 7B:

TABLE 7A
Example Compositions

| | | HDPE | | | | |
|---|---|---|---|---|---|---|
| | HDPE | Marlex | Graphite | Ketjen | | |
| | Formolene | HHM | TIMREX | black | Total | Total |
| Comp. | HL5010 | 4903 | KS44 | EC300J | Carbon | HDPE |
| Ex12 | 58 | | 29 | 13 | 42 | 58 |
| Ex13 | | 49 | 38 | 13 | 51 | 49 |

TABLE 7B
Properties of Table 7A Compositions

| | | VR ASTM D991 |
|---|---|---|
| Composition | Thickness | (Ohm · cm) |

| | | | |
|---|---|---|---|
| Ex12 | 3.2 | mm | 0.30 |
| | 0.025 | inch | 0.92 |
| | 0.038 | inch | 0.83 |
| | 0.052 | inch | 0.69 |
| Ex13 | 3.2 | mm | 0.37 |
| | 0.025 | inch | 0.46 |
| | 0.049 | inch | 0.35 |

The Marlex HDPE has a degree of crystallinity of 58.6% as determined according to DSC. Both compositions had good chemical resistance and volume resistivity and were successfully scaled up on a commercial-size sheet extruder to make sheets of 0.025″, 0.037″ and 0.050″ thicknesses. Ex12 extruded more easily than Ex13, however. The sheets including Ex13 were brittle in both directions. The mechanical properties of the Ex12 and Ex13 compositions are provided in Table 7C:

TABLE 7C
Mechanical Properties of Ex12 and Ex13

| | Ex12 | | Ex13 | |
|---|---|---|---|---|
| | Room | | Room | |
| Property | Temperature | 60° C. | Temperature | 60° C. |
| Tensile strength at | 30.9 | 19 | 31.3 | 19.7 |
| yield (megapascal) | | | | |
| (MPa) ASTM D 638 | | | | |
| Tensile strength at | 30.1 | 17.9 | 31.2 | 19.4 |
| break (MPa) | | | | |
| ASTM D 638 | | | | |
| Tensile Modulus | 3956 | 2079 | 5366 | 2814 |
| (MPa) ASTM D 638 | | | | |
| Tensile elongation at | 4.2 | 6.1 | 1.8 | 3.6 |
| yield (%) | | | | |
| ASTM D 638 | | | | |
| Tensile elongation at | 5.2 | 8.9 | 1.9 | 4.3 |
| break (%) | | | | |
| ASTM D 638 | | | | |
| Flexural strength at | 48.1 | 28.3 | 50.4 | 29.6 |
| yield (MPa) | | | | |
| ASTM D 790 | | | | |
| Flexural modulus | 2190 | 1075 | 3450 | 1539 |
| (MPa) ASTM D 790 | | | | |
| Coefficient of thermal | Flow = 89, xFlow = 94 | | Flow = 63, xFlow - 89 | |
| expansion from 23- | | | | |
| 60° C. (μm/(m-° C.) TMA | | | | |

The results of Table 7C may explain the difference in ductility observed in sheets made using the compositions of Ex12 and Ex13 on a commercial-size extruder. As Table 7C shows, the values of tensile elongation at yield and tensile elongation at break of Ex12, at both RT and at 60 C, were about double compared to those of Ex13, suggesting that a better elongation behavior correlates with better ductility in extruded sheets.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects can be combined with each other in various combinations or permutations. The scope of the disclosure should be determined with reference to the appended claims, along with the full scope of equivalents to which such claims are entitled.

1. A composition comprising:
from about 35 wt % to about 70 wt % of at least one polyethylene polymer;
from about 25 wt % to about 55 wt % of at least one graphite filler; and
from about 2 wt % to about 15 wt % of a carbon powder filler having a BET surface area of at least 50 square meters per gram (m²/g) as determined in accordance with ASTM D3037, wherein
the polyethylene polymer has a density of at least 0.94 gram per cubic centimeter (g/cm³) as determined in accordance with ASTM D1505, a melt flow rate (MFR) of at least 10 g per 10 minutes (g/10 min) measured at 190° C. and 21.6 kilogram (kg) in accordance with ASTM D1238, and an Environmental Stress-Cracking Resistance (ESCR) measured in a 100% Igepal solution of at least 500 hours in accordance with ASTM D1693,
the composition has a volume electrical resistivity of less than 5 ohm·centimeter (ohm·cm) measured in accordance with ASTM D991 or ASTM D257,
the composition has a MFR of at least 4 g/10 min measured at 280° C. and 21.6 kg in accordance with ASTM D1238,
the combined weight percent value of all components does not exceed 100 wt %, and
all weight percent values are based on the total weight of the composition.

2. The composition according to claim 1, wherein the polyethylene polymer comprises a copolymer comprising ethylene monomer and hexene monomer.

3. The composition according to claim 1, wherein the polyethylene polymer has a degree of crystallinity of at least 50% as determined by differential scanning calorimetry (DSC).

4. The composition according to claim 3, wherein the polyethylene polymer has a degree of crystallinity of from 50% to 95% as determined by differential scanning calorimetry (DSC).

5. The composition according to claim 1, wherein the graphite is a synthetic graphite.

6. The composition according to claim 1, wherein the carbon powder filler has a BET surface area of at least 60 square meters per gram (m²/g) as determined in accordance with ASTM D3037.

7. An extruded sheet comprising the composition according to claim 1.

8. The extruded sheet according to claim 7, wherein the sheet has a thickness of from 0.020 inches (in) to 0.060 in.

9. A method for forming a composition comprising from about 35 wt % to about 70 wt % of at least one polyethylene polymer, from about 25 wt % to about 55 wt % of at least one graphite filler, and from about 2 wt % to about 15 wt % of a carbon powder filler having a BET surface area of at least 50 square meters per gram (m²/g) as determined in accordance with ASTM D3037, the method comprising:
combining the at least one polyethylene polymer, the at least one graphite filler and the carbon powder filler to form a mixture; and
extruding the mixture to form the composition,
wherein
the polyethylene polymer has a density of at least 0.94 gram per cubic centimeter (g/cm³) as determined in accordance with ASTM D1505, a melt flow rate (MFR) of at least 10 g per 10 minutes (g/10 min) measured at 190° C. and 21.6 kilogram (kg) in accordance with ASTM D1238, and an Environmental Stress-Cracking Resistance (ESCR) measured in a 100% Igepal solution of at least 500 hours in accordance with ASTM D1693,
the composition has a volume electrical resistivity of less than 5 ohm·centimeter (ohm·cm) measured in accordance with ASTM D991 or ASTM D257,
the composition has a MFR of at least 4 g/10 min measured at 280° C. and 21.6 kg in accordance with ASTM D1238,
the combined weight percent value of all components does not exceed 100 wt %, and
all weight percent values are based on the total weight of the composition.

10. The method according to claim 9, wherein the polyethylene polymer comprises a copolymer comprising ethylene monomer and hexene monomer.

11. The method according to claim 9, wherein the polyethylene polymer has a degree of crystallinity of at least 50% as determined by differential scanning calorimetry (DSC).

12. The method according to claim 11, wherein the polyethylene polymer has a degree of crystallinity of from 50% to 95% as determined by differential scanning calorimetry (DSC).

13. The method according to claim 9, wherein the graphite is a synthetic graphite.

14. The method according to claim 9, wherein the carbon powder filler has a BET surface area of at least 60 square meters per gram (m²/g) as determined in accordance with ASTM D3037.

15. The method according to claim 9, wherein the composition is extruded into a sheet having a thickness of from 0.020 inches (in) to 0.060 in.
